(19) United States
(12) Patent Application Publication
(10) Pub. No.: US 2018/0085960 A1
(43) Pub. Date: Mar. 29, 2018

(54) Manually Operated Knife Guide

(71) Applicant: Steven Hucles Roberts, San Antonio, TX (US)

(72) Inventor: Steven Hucles Roberts, San Antonio, TX (US)

(21) Appl. No.: 15/275,260

(22) Filed: Sep. 23, 2016

(51) Int. Cl. B26B 29/06

(52) U.S. Cl. CPC B26B 29/063; B26B 2029/066

(57) ABSTRACT

A manual method and apparatus for guiding a knife blade along a linear plane to produce a linear planar surface at a variably adjustable distance from a contact point.

### CROSS-REFERENCE

Application No. 62/232,453

### BACKGROUND OF THE INVENTION

Slicing devices of diverse construction have been proposed for slicing items such as meats, breads and fruits into thin, evenly sliced portions. Some shortcoming generally in many of the devices in the current art are a requirement an electric power supply, have a short maximum range slicing length capability, are large in structure, require considerable storage space and can be cumbersome to clean. Shortcoming in the present manually operated devices appear to be in their control and stability of the device while in use, have a short maximum range slicing length capability, and only offer limited control over the angular plane of travel of the knife blade in application.

(Espacenet: GERGAUD MICHEL [FR]-FR2355623 (A1)—1978-01-20)—(https://worldwide.espacenet.com/publicationDetails/mosaicsj sessionid=m019JSt-xR117ufmbYP4Kr60.espacenet_levelx_prod_1? CC=FR&NR=2355623A1&KC=A1&FT=D&ND=3&date=19780120&DB=worldwide. espacenet.com&locale=en_EP)

### BRIEF SUMMARY OF THE INVENTION

In light of the presented issues with the prior art, it is a principal object of the invention to provide a means for slicing meat and other items into variable thickness slices while providing greater control, stability and safety over the cutting path of the knife blade and the slicing operation in general.

It is another object of the invention to provide a knife guide of the type described with a handle attached to the top of the knife guide which serves to provide greater control over the device during the intended use of slicing operations.

It is an object of the invention to provide improved elements and arrangements in a manually operated knife guide which is uncomplicated in construction, inexpensive to manufacture, light in weight, dependable in use, simple to clean and maintain, requiring little storage space, requiring no electrical power source, offering enhanced safety during use and otherwise well adapted in accomplishing its intended objectives.

Briefly, a knife guide in accordance with this invention achieves the intended objectives in one embodiment by featuring a handle attached to a rectangular plate with the two flanged sides having identical elongated slots for adjusting slice thickness and guiding a knife blade along a planar path while being held against an item to be sliced to produce a single or multiple equivalent thickness slices.

The foregoing and other objects features and advantages of the present invention will become readily apparent upon further review of the following detailed description of the preferred embodiment as illustrated in the accompanying drawings.

### BRIEF DESCRIPTION OF DRAWINGS

The present invention may be more readily described with reference to the accompanying drawing, in which:

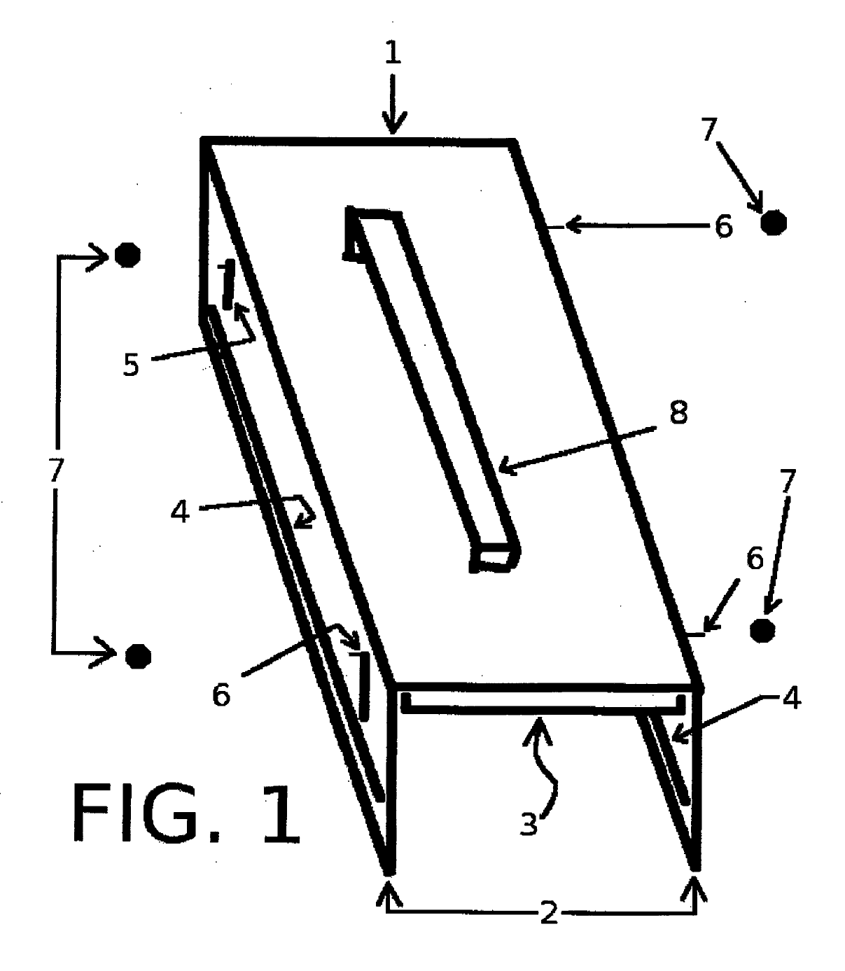

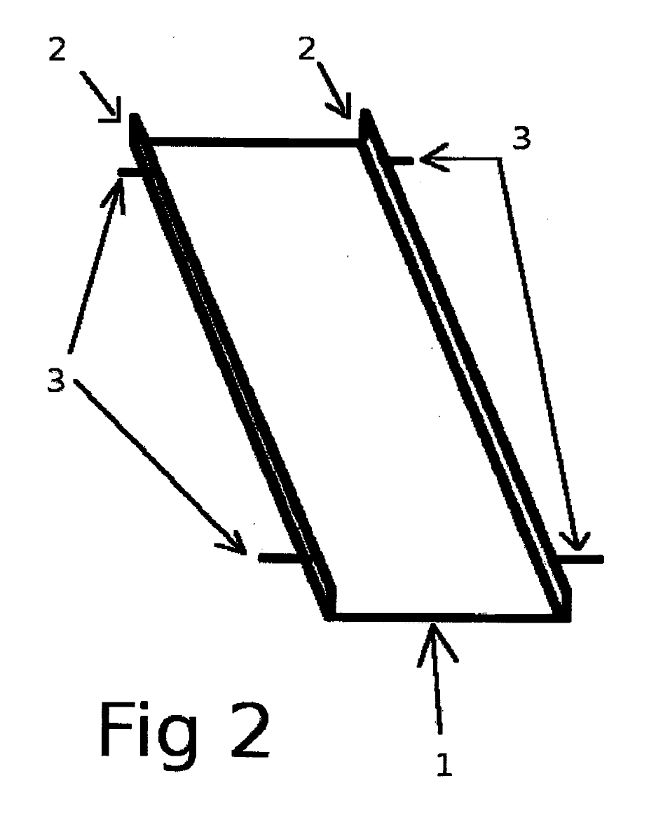

FIG. 1—The preferred embodiment of the invention—comprising two pieces
1. Control Handle (8), Planar Main Body Frame Section (1) with incorporated perpandicularly attached planar knife guide control sections (2)
3. Separate Slip Resistant Contact Surface Plate (3) (shown in FIG. 2 and FIG. 3)
4. Knife Guide Slot for guiding a knife blade along a linear plane
5. Slice Thickness Adjustment Slot
6. Slice Thickness Adjustment Slot Studs attached to the Contact Surface Plate
7. Slice Thickness Adjustment Stud Fastener

FIG. 2
1. Top view of separate slip resistant contact surface from FIG. 1
2. Thickness Adjustment Stud Support Flange Sections
3. Thickness Adjustment Stud Screws

FIG. 3
1. Bottom (Contact Side) View of Slice Item Contact Surface from FIG. 1
2. Thickness Adjustment Stud Screws and Stud Flange Sections
3. Slip Resistant Surface Treatment
4. Flanged sections bent 90 degrees opposite the texture surface

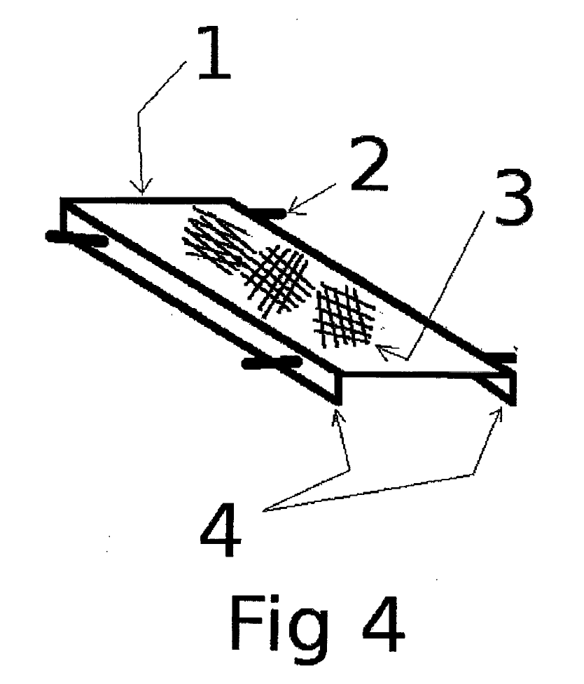

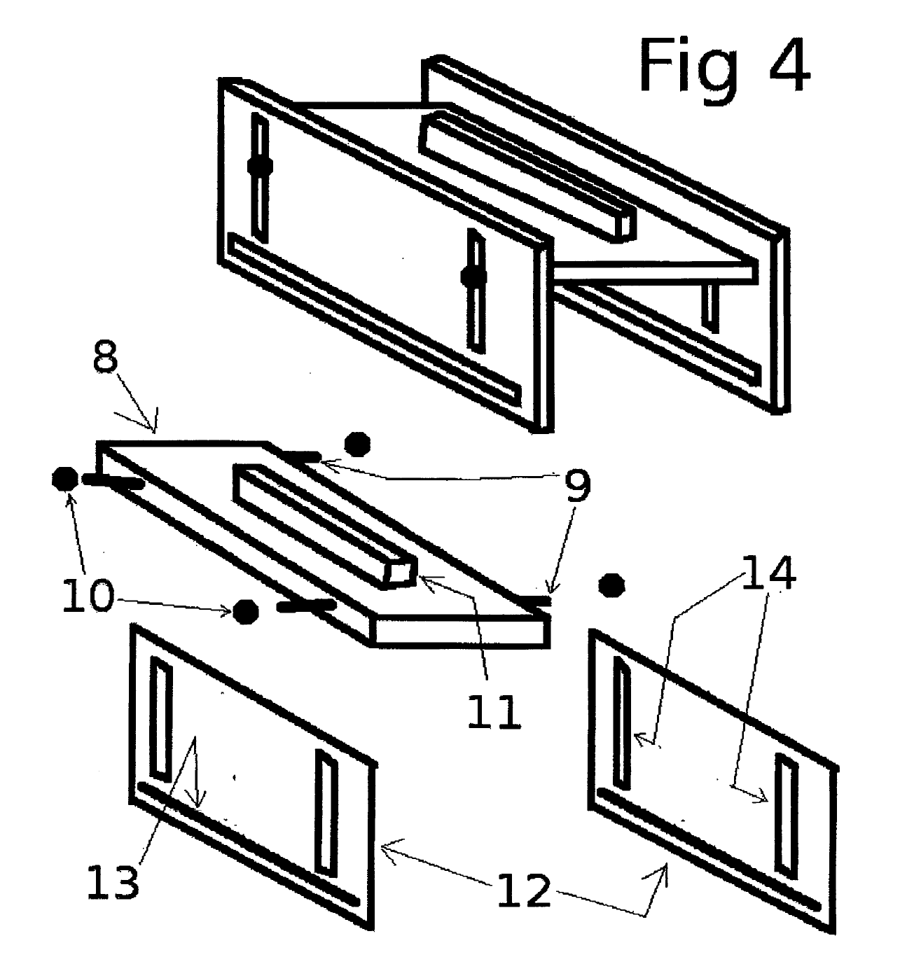

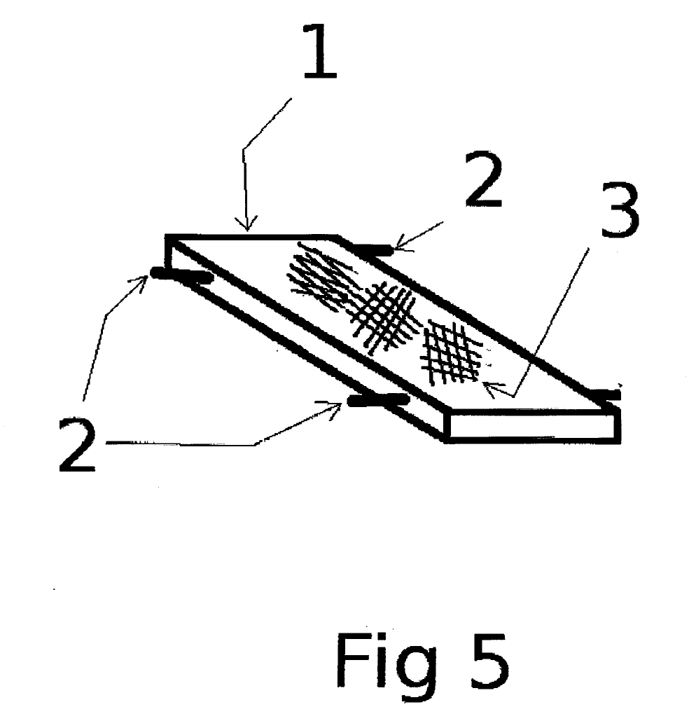

FIG. 4—An alternate embodiment of the invention—comprising three pieces
8-14. One piece Control Handle (11), Planar Main Body Frame Section (8) with incorporated Slip Resistant Surface Treatment (FIG. 5)
8. Separate Slip Resistant Contact Surface Plate (3) (shown in FIG. 2 and FIG. 3)
9. Slice Thickness Adjustment Slot Studs attached to the Contact Surface Plate
10. Slice Thickness Adjustment Studs
11. Slice Thickness Adjustment Stud Fasteners
12. Two Perpandicularly Attached Planar Knife Guide Control Sections
13. Knife Guide Slot for guiding a knife blade along a linear plane
14. Slice Thickness Adjustment Slots

FIG. 5—Bottom View of Slice Item Contact Surface from FIG. 4
1. One piece Control Handle (11), Planar Main Body Frame Section (8) with incorporated Slip Resistant Surface Treatment on surface opposite the handle surface
2. Thickness Adjustment Stud Fasteners
3. Slip Resistant Surface Treatment

### DETAILED DESCRIPTION OF THE INVENTION

The apparatus shown in FIG. 1 is the preferred embodiment of the invention. The invention is proposed for evenly slicing food stuffs. This said embodiment essentially has two component part pieces comprising (part 1) the handle, body frame and flange slice control sections as an assembled unit and (part 2) the slip resistant contact plate with attached adjustment studs.

The unit can be constructed by creating a single piece unit consisting of the control handle (FIGS. 1-8), a planar main body frame section with incorporated perpandicularly attached planar knife guide control sections (FIG. 1—items 1, 2 and 8). This embodiment could be constructed from food grade stainless steel. Start with a blank 12 inches long by 9 inches wide. Cut two (2) knife guide slots (FIG. 1—item 4) 3/16 inch wide slots through the blank material to within ⅛ inch from the length and width edges along both 12 inch edges. Cut four (4) 3/16 inch wide thickness adjustment slots 1 and ⅝ inches long through the material beginning 1 inch from each 9 inch edge and ⅛ inch from the knife guide slot or 5/16 inch from the 12 inch blank edge, cutting toward the center of the blank. Cut the adjustment slots (FIG. 1—item 5) along a path from the start point and parallel to the 9 inch edge of the blank extending 1 and ⅝ inches. Securely attach a handle (FIG. 1—item 8) centered on the main body frame blank. Bend two (2) (FIG. 1—item 2) 2.5 inches wide flange sections 90 degrees, in opposite direction from the handle and parallel to each 12 inch edge. Each of the two flange sections should match each other containing a knife guide slot and two (2) thickness adjustment slots. Next create the slip resistant contact plate (FIG. 2 and FIG. 3). Start with a blank 12 inches by 4.5 inches. Create a slip resistant surface by making cross hash cuts 0.25 inch apart (FIG. 1—item 3), but ensuring to not cut through the material, to create a textured, limited slip surface defined to be 1 inch wide extending 0.5 inch of either side of center for the entire length of and parallel to each 12 inch edge. Bend two (2) flanges 90 degrees (FIG. 3—item 4), in the direction opposite the slip resistant surface, ¼ inch wide or 0.25 inch from and parallel to each 12 inch contact surface blank edge. Attach two (2) (FIG. 3—item 2) 8/32 stud bolts on each contact surface blank flange section centered approximately at 15/16 inch from the 0.25 inch edge and 2/16 inch from or between each 12 inch edge. The contact plate studs must align with the thickness adjustment slots in the main assembly (FIG. 1—items 5 and 6). Assemble the completed component parts into a completed unit (FIG. 1) by inserting the contact surface plate with the slip resistant surface showing when viewed from the bottom (FIG. 1—item 3) and the 0.25 inch flange sections of the contact plate facing upward toward the main body section. Insert the contact plate between the two flange sections of the main body section unit ensuring the thickness adjustment studs are properly aligned and extend freely through the thickness adjustment slots. Attach the adjustment stud tightening fasteners (FIG. 1—item 7).

To use the defined invention, set the slice thickness by loosening the adjustment fasteners, adjust the contact plate to the desired slice thickness and tighten the adjustment fasteners. Insert a long bladed knife through each of the knife guide slots. Draw the dull knife edge back against the end of the knife guide slot. Place the knife guide invention with inserted knife over and in contact with the item to be sliced, such as a loaf of bread. Then moving the knife in a reciprocating motion while ensuring to not use too broad of a stroke causing the knife to disengage from either of the knife guide slots, begin the slicing operation by moving the knife blade along the knife guide slot and through the item to be sliced. Once the knife reaches the other end of the knife guide slot, withdraw and remove the knife, lift the and remove the invention and remove your slice.

What is claimed is:

1. Method for manually guiding a knife blade along a linear plane of travel while slicing items of varying lengths at variable thicknesses comprising:
a handle
and
a planar main body frame section
and
a slip resistant contact surface
and
two perpandicularly attached planar knife guide control sections.

2. The method in claim 1, wherein the handle is generally used to stabilize the device and to control the device's roll, pitch and yaw angles during use in application.

3. The method in claim 2, wherein the handle is attached to the planar main body frame section.

4. The method in claim 1, wherein the said two perpandicularly attached planar knife guide control sections provide means for guiding a knife blade along an intended linear plane of travel.

5. The method in claim 4, wherein the said two perpandicularly attached planar knife guide control sections provide means for increasing or decreasing the distance between a contact surface on an item to be sliced and the intended linear slice plane produced by a knife blade in use with the invention when sliced through an item.

6. The method in claim 1, wherein the preferred embodiment, the handle, planar main body frame section and the two perpandicularly attached planar knife guide control sections are formed as a single unit.

7. The method in claim 6, wherein said preferred embodiment comprises a separate slip resistant contact surface plate which is attached to the said one piece unit of the handle, planar main body frame section with incorporated perpandicular planar knife guide control sections single unit assembly.

8. The method in claim 1, wherein an alternate embodiment, the handle, planar main body frame section and the slip resistant contact surface are in one piece with the handle attached to the planar main body frame section opposite the slip resistant contact surface.

9. The method in claim 8, wherein said alternate embodiment comprises two separate perpandicularly attached planar knife guide control sections separately attached to the said single unit handle, planar main body frame section, slip resistant surface.
whereby, using the described invention to guide a knife blade along a linear plane of travel during a slicing operation will produce a slice of a intended thickness from the item sliced.
